(19) United States
(12) Patent Application Publication
(10) Pub. No.: US 2008/0080693 A1
(43) Pub. Date: Apr. 3, 2008

(54) Response system

(75) Inventor: Kazuya MORI, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/892,349

(22) Filed: Aug. 22, 2007

(30) Foreign Application Priority Data
Sep. 28, 2006 (JP) 2006-264409

(51) Int. Cl. H04M 3/42

(52) U.S. Cl. 379/214.01; 379/215.01

(57) ABSTRACT

A response system includes at least one response terminal and a response management apparatus. The response terminal includes a status sending part that sends an inherent identification number and the status information. The response management apparatus includes: an incoming call receiving part that receives an incoming call from a calling terminal; a repeated call determination part that determines whether or not the origination number is the origination number at which the call communication is disconnected; a response management storage part that holds the status information; an incoming call distributor part that selects and connects a response terminal making a response to the call of the calling terminal, based on the determination result of the repeated call determination part and the status information held in the response management storage part; and a status information management part that manages the status information for the at least one response terminal held in the response management storage part.

### CROSS-REFERENCE TO RELATED APPLICATION

This application claims priority under 35 USC 119 from Japanese Patent Application No. 2006-264409, the disclosure of which is incorporated by reference herein.

### BACKGROUND OF THE INVENTION

1. Field of the Invention

The present invention relates to a response system, a response management apparatus, a response terminal and a response management method.

2. Description of the Invention

In recent years, customer satisfaction has increased in importance. Conventionally, there have been made efforts for enhancing the customer satisfaction. For example, a call center is provided to deal with phone calls from the customers. However, if the customer (calling side) who makes a call to the call center has a long waiting time, or the so-called “run-around state” (routing a call from one person to another) occurs, customer satisfaction becomes inversely lower. Accordingly, to keep or improve customer satisfaction, the call center is not only installed, but also how to shorten the waiting time of the customer (calling side) making a phone call to the call center, or how to prevent the “run-around” is more important.

In this situation, for example, when the call is disconnected due to a radio disturbance, and the same customer calls again to the call center, the call is connected to not the person in charge (operator) who deals with the call before call disconnection but another person in charge, owing to an automatic call distribution function (ACD function) provided for a response management apparatus (computer) of the call center, resulting in a problem that the run-around state occurs.

A technique concerning the reconnection of call between portable communication apparatuses such as PHS (Personal Handyphone System) is described in Japanese Patent Application Laid-Open No. 8-307949, for example.

However, the prior art concerning the reconnection of call can not be applied to, for example, a response system of the call center having an automatic call distribution function (ACD function) capable of changing the destination of connection depending on the occasion in which one or more called terminals capable of dealing with a call of the calling terminal, because it is presupposed that the called terminal that deals with the call of the calling terminal is uniquely specified.

### SUMMARY OF THE INVENTION

The present invention provides a new and improved response system, response management apparatus, response terminal and response management method in which when a calling terminal has a call disconnected and makes a call again, the calling terminal can be reconnected to a response terminal with which the calling terminal makes the call communication before call disconnection.

According to an aspect of the invention, there is provided a response system that includes at least one response terminal; and a response management apparatus connected to the at least one response terminal. The response terminal includes a status sending part that sends an inherent identification number and the status information indicating at least a repeated call waiting state. The response management apparatus includes: an incoming call receiving part that receives an incoming call from a calling terminal having an inherent origination number; a repeated call determination part that determines whether or not the origination number of the calling terminal from which the incoming call is received by the incoming call receiving part is the origination number at which the call communication is disconnected; a response management storage part that holds the status information set at the at least one response terminal; an incoming call distributor part that selects and connects a response terminal making a response to the call of the calling terminal from the at least one response terminal, based on the determination result of the repeated call determination part and the status information held in the response management storage part; and a status information management part that manages the status information for the at least one response terminal held in the response management storage part.

### BRIEF DESCRIPTION OF THE DRAWINGS

FIG. 1 is an explanatory diagram showing a problem with the conventional response system.

FIG. 2 is a block diagram showing a response system according to an embodiment of the present invention.

FIG. 3 is an explanatory view showing one example of information held in a response management storage part of a response management apparatus according to the embodiment of the present invention.

FIGS. 4A and 4B are explanatory diagrams showing the reconnection operation after call disconnection in the response system according to the embodiment of the present invention.

FIG. 5 is a flowchart showing a method for setting the status of a response terminal to a repeated call waiting state in the response system according to the embodiment of the present invention.

FIG. 6 is a flowchart showing a method for clearing the repeated call waiting state set in the response terminal in the response system according to the embodiment of the present invention.

FIG. 7 is a flowchart showing a response management method for use in the response management apparatus making up the response system according to the embodiment of the present invention.

### DETAILED DESCRIPTION OF THE INVENTION

The preferred embodiments of the present invention will be described below in detail with reference to the accompanying drawings. In the specification and drawings, the parts having the same or almost same functions are denoted by the same reference numerals, and the duplicate explanation of those same parts is omitted.

### (Problems with the Conventional Response System)

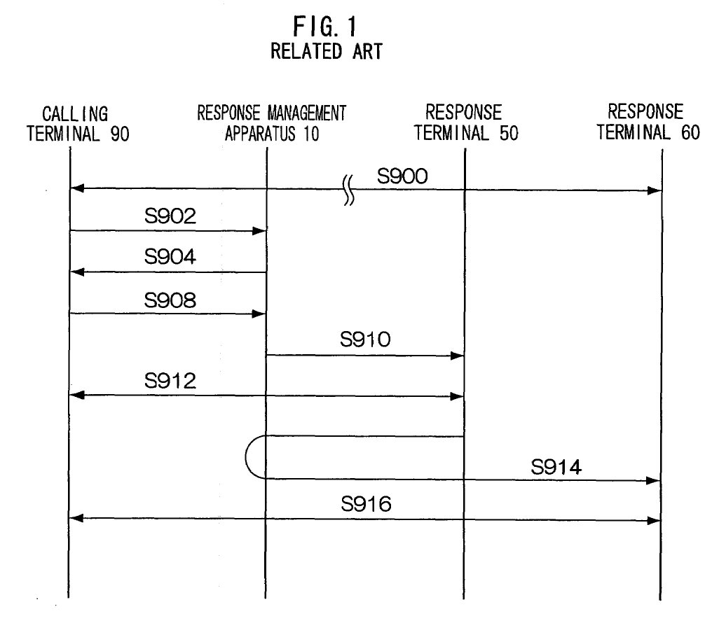

First of all, the problems with the conventional response system will be described below. FIG. 1 is an explanatory diagram showing the problems with the conventional response system.

The conventional response system comprises at least a response management apparatus 10 and the response terminals 50 and 60, and gets an incoming call from a calling terminal 90. The response management apparatus 10 has an automatic call distribution (Automatic Call Distributor) function (hereinafter referred to as an “ACD function) to connect properly the response terminal 50 or 60 and the calling terminal 90. Each of the response terminals 50 and 60 is a communication apparatus that makes the communication with the calling terminal 90. Also, the calling terminal 90 is a portable communication apparatus such as a portable telephone or a fixed communication apparatus such as a fixed telephone, for example. Referring to FIG. 1, the problem in the case where the call communication between the calling terminal 90 and the response terminal 60 is disconnected will be described below.

If the call communication between the calling terminal 90 and the response terminal 60 is disconnected (S900), the calling terminal 90 makes a repeated attempt (hereinafter referred to as a “repeated call”) (S902). The response management apparatus 10 receives the repeated call at step S902, and makes an automatic response, for example, through Interactive Voice Response (hereinafter referred to as “IVR”) (S904). The calling terminal 90 communicates or selects the outline of requirement, for example, in accordance with the automatic response at step S904 (S908). The response management apparatus 10 is connected to the response terminal 50 by the ACD function, based on the communicated or selected contents from the calling terminal 90 as indicated at step S908 (S910). The call communication between the calling terminal 90 and the response terminal 50 is established through the above steps S902 to S910 (S912).

Herein, the response terminal 50 connected at step S910 is different from the response terminal that has been engaged in the call communication immediately before call disconnection at step S900. Accordingly, the response terminal 50 reconnects the response terminal 60 that is the response terminal engaged in the call communication immediately before call disconnection at step S900 and the calling terminal 90 via the response management apparatus 10 (S914). At step S914, the call communication between the calling terminal 90 and the response terminal 60 is established (S916).

In the conventional response system as shown in FIG. 1, in order that the calling terminal 90 and the response terminal 60 are reconnected for call communication, the response terminal 50 that is another response terminal may be interposed. Accordingly, in the conventional response system, when the calling terminal where call disconnection occurs makes a call again, the calling terminal may not be always reconnected directly to the response terminal engaged in the call communication immediately before call disconnection.

Especially in the case where the conventional response system is the response system for dealing with the customer in the call center, for example, a so-called “run-around state” is brought about at steps S912 to S916 as shown in FIG. 1, degrading the customer satisfaction of the customer who operates the calling terminal 90.

### Embodiments

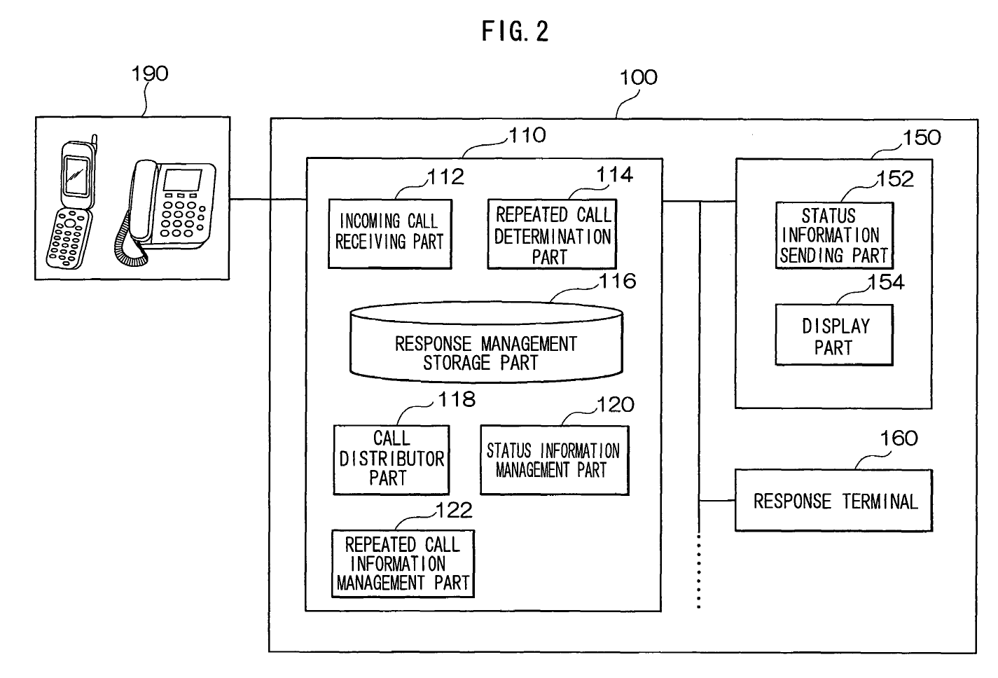

The embodiments of the present invention will be described below. FIG. 2 is a block diagram showing a response system 100 according to an embodiment of the present invention.

Referring to FIG. 2, the response system 100 according to the present invention comprises a response management apparatus 110, and the response terminals 150, 160, . . . , and receives an incoming call from the calling terminal 190. Herein, the calling terminal 190 is a portable communication apparatus such as a portable telephone or PHS, or a fixed communication apparatus such as a fixed telephone set, and has an inherent origination number (i.e., telephone number).

The response terminal 150 is the apparatus that makes the call communication (response) with the calling terminal 190, and has an inherent identification number. Also, the response terminal 150 comprises a status information sending part 152, a display part 154, and a communication part that can communicate with the response management apparatus 110. The status information sending part 152 plays a role of sending a status of the response terminal 150 to the response management apparatus 110. Herein, the statuses sent by the status information sending part 152 include a “log-off” indicating the non-operating state of the response terminal 150, an “out of seat” indicating the temporary non-operating state of the response terminal 150, a “work time” indicating the post-processing of the response terminal 150, and a “repeated call waiting” indicating the state waiting for repeated call after the call communication with the calling terminal 190 is disconnected. The display part 154 displays information sent from the response management apparatus 110, such as repeated call incoming information indicating that there is a repeated call from the calling terminal 190, for example. The response terminal 160, . . . also has the same components and functions.

The response management apparatus 110 comprises at least an incoming call receiving part 112, a repeated call determination part 114, a response management storage part 116, a call distributor part 118, a status information management part 120, a repeated call information management part 122, and a communication part that can communicate with each of the response terminals 150, 160, . . . .

The incoming call receiving part 112 receives an incoming call from the calling terminal 190, and holds an inherent origination number that the calling terminal 190 has. Herein, the incoming call receiving part 112 has an IVR function, and can automatically make a voice response to the calling terminal 190 and/or send the character information to the calling terminal 190.

The repeated call determination part 114 determines whether or not the origination number held in the incoming call receiving part 112 is repeated call. Herein, the repeated call determination of the repeated call determination part 114 will be described later.

The response management storage part 116 comprises holds at least the status information indicating the response terminal state of each of the response terminals 150, 160, . . . . Herein, the statuses indicated by the status information include a “log-off” indicating the non-operating state of the response terminal 150, an “on standby” indicating the state where the call communication is on standby, a “telephone conversation” indicating that the telephone conversation is in progress, an “out of seat” indicating the temporary non-operating state of the response terminal, a “work time” indicating the post-processing of the response terminal 150, and a “repeated call waiting” indicating the state waiting for repeated call, for example. In the case where the incoming call receiving part 112 has an IVR function, the IVR information on the IVR function may be held in the response management storage part 116.

The call distributor part 118 is connected to the calling terminal 190 and any of the response terminals, based on the repeated call determination result of the repeated call determination part 114 and the status information held in the response management storage part 116. For example, if the repeated call determination part 114 determines that the call is repeated call, the call distributor part 118 is connected to the response terminal in which the status information is “repeated call waiting” and the inherent identification number that the response terminal has is matched. Also, if the repeated call determination part 114 determines that the call is not repeated call, the call distributor part 118 is connected to any of the response terminals in which the status information is “on standby”. Also, when the call distributor part 118 is connected to the response terminal, the origination number of the calling terminal 190 for connection may be notified to the response terminal.

Accordingly, the response management apparatus 110 has an ACD function by comprising the call distributor part 118, but is different from the conventional response management apparatus 10 having the ACD function as shown in FIG. 1, in that it can be connected (reconnected) to the response terminal in which the status information is “repeated call waiting”, and the inherent identification number that the response terminal has is matched with. In the case where there is no response terminal in which the status information is “repeated call waiting” though the repeated call determination part 114 determines that the call is repeated call, or there is no response terminal in which the inherent identification number that the response terminal has is matched with, it can be connected to any of the response terminals in which the status information is “on standby”.

The status information management part 120 makes the management for setting or changing the status information indicating the status of each of the response terminals 150, 160, . . . held in the response management storage part 116. For example, in the case where the response terminal 150 indicating that the status information is “on standby” is connected to the calling terminal 190, the status information management part 120 changes the status of the response terminal 150 to “during call communication”. And if the call communication between the response terminal 150 and the calling terminal 190 is ended, the status of the response terminal 150 is changed from “during call communication” to “on standby”.

Also, the status information management part 120 changes the status of the response terminal corresponding to the sent status information in accordance with the status information sent from each of the response terminals 150, 160, . . . . For example, in the case where the status information indicating “log-off” is sent from the response terminal 160 indicating that the status information is “on standby”, the status information management part 120 changes the status of the response terminal 160 from “on standby” to “log-off”. Also, in the case where the status information indicating the “repeated call waiting” is sent from the response terminal 150, the status information management part 120 changes the status of the response terminal 150 to “repeated call waiting”.

The repeated call information management part 122 registers the repeated call information in the response management storage part 116, if the status information indicating the “repeated call waiting” is sent from each of the response terminals 150, 160, . . . . Also, a repeated call capable status indicating the state capable of repeated call is set in the repeated call information. Herein, the repeated call capable statuses include a “repeated call waiting” indicating the repeated call waiting state and a “repeated call ready” indicating that the disposition for repeated call is completed, for example.

Also, the repeated call information management part 122 sets the registration start time (time information) indicating the time when the repeated call information indicating that the status information is “repeated call waiting” is sent from the response terminal, and registered in the response management storage part 116 as the repeated call information. If a predetermined time passes, the repeated call capable status of the registered repeated call information is set to “time over” to invalidate the repeated call information. The predetermined time can be appropriately set.

### [Repeated Call Determination Method of Repeated Call Determination Part 114]

The above repeated call determination part 114 makes the repeated call determination based on the origination number held in the incoming call receiving part 112 and the repeated call information registered or changed by the repeated call information management part 122. For example, if the repeated call waiting number corresponding to the origination number exists in the repeated call information, and the repeated call capable status of the pertinent repeated call information is “repeated call waiting”, the repeated call determination part 114 determines that the call received by the incoming call receiving part 112 is repeated call. Also, if the repeated call waiting number corresponding to the origination number does not exist in the repeated call information, the repeated call determination part 114 does not determine that the call received by the incoming call receiving part 112 is repeated call. Also, if the repeated call capable status of the pertinent repeated call information is “repeated call ready” or “time over”, even though the repeated call waiting number corresponding to the origination number exists in the repeated call information, the repeated call determination part 114 does not determine that the call received by the incoming call receiving part 112 is repeated call.

As described above, in the response management apparatus 110 according to the embodiment of the invention, the repeated call information management part 122 changes the repeated call capable status of the repeated call information in which a predetermined time passes since registration to “time over” to invalidate the pertinent repeated call information. That is, the repeated call determination part 114 does not determine that the call is repeated call, using the repeated call information in which the repeated call capable status is “time over”. In this manner, in the response system 100 according to the embodiment of the invention, the response terminal does not wait for repeated call more than necessary by restricting the duration of repeated call waiting state where the response terminal waits for repeated call to the predetermined time, whereby the efficient response management can be made. Accordingly, in the case where the response system 100 according to the embodiment of the invention is applied to the response system for customer in the call center, for example, the customer is treated efficiently, whereby the customer satisfaction is prevented from being degraded and improved by shortening the waiting time of the customer (calling terminal) making a phone call to the call center.

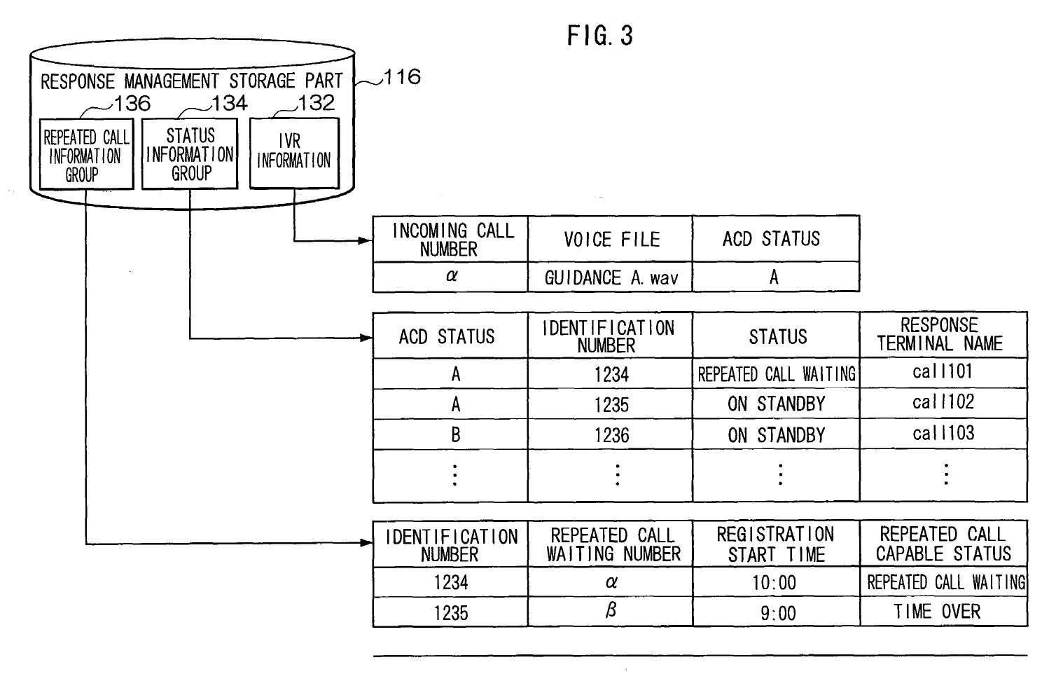

Next, the operation of the response management apparatus 110 in the case where the incoming call receiving part 112 has an IVR function will be described below. FIG. 3 is an explanatory view showing one example of information held in the response management storage part 116 of the response management apparatus 110 according to the embodiment of the invention. Referring to FIG. 3, the response management storage part 116 has the IVR information 132, a status information group 134, and a repeated call information group 136. The IVR information 132 has an incoming call number indicating the origination number received by the incoming call receiving part 112, a voice file with respect to the IVR function, and an ACD status with respect to the ACD function. Also, the status information held in the status information group 134 has an ACD status with respect to the ACD function, identification information for identifying the response terminal, a status indicating the state of the response terminal, and a response terminal name as auxiliary information. Further, the repeated call information held in the repeated call information group 136 has an identification number of identifying the response terminal involving the call communication where call disconnection occurs, a repeated call waiting number indicating the origination number of the calling terminal involving the call communication where call disconnection occurs, a registration start time indicating the time when the repeated call information is registered, and a repeated call capable status indicating the state of repeated call information.

In the case where the incoming call receiving part 112 has the IVR function, the calling terminal may be presented with a selection menu for making a selection. That is, the call distributor part 118 can be connected to the response terminal satisfying the desired condition of the calling terminal by using the selection result from the calling terminal. In FIG. 3, the ACD status is provided in the IVR information 132 and the status information held in the status information group 134. For example, when the calling terminal having the origination number “α” makes the selection corresponding to the ACD status “A” for IVR, the call distributor part 118 extracts the status information with the ACD status of “A” from the status information group 134, and selects the response terminal having the identification number of “1234” or “1235” as a response terminal candidate for connection. Also, at this time, the repeated call determination part 114 determines whether or not the calling terminal with the origination number “α” makes a repeated call, based on the repeated call determination method as described above, and determines that the response terminal having the identification number of “1234” waits for repeated call from the origination number “α”.

Next, the call distributor part 118 checks the determination result in the repeated call determination part 114 and the status of extracted status information. From the above, the response management apparatus 110 connects the calling terminal having the origination number “α” to the response terminal “1234” waiting for repeated call from the origination number “α”.

Accordingly, in the response system 100 according to the embodiment of the invention, the calling terminal can be reconnected to the response terminal that has been connected before call disconnection occurs, when there is a call again from the calling terminal where call disconnection occurs, irrespective of whether or not the response management apparatus 110 has the IVR function.

Also, in the case where the response system 100 according to the embodiment of the invention is applied to the response system for customer such as call center, for example, a so-called “run-around state” is not caused, whereby it is unnecessary that the customer explains the call communication contents where call disconnection occurs such as inquiry contents duplicately. Also, since there is no influence of the “run-around state” on the acceptance affair of the operator (person who uses the response terminal) in the call center, the customer is treated efficiently. Accordingly, the customer satisfaction of the customer (calling terminal) making a phone call to the call center is prevented from being degraded and improved.

FIG. 3 is one example of information held in the response management storage part 116. The information held in the response management storage part 116 is not limited to that of FIG. 3. For example, the status information of the status information group 134 may not be information without item of the response terminal name, or the status information of the status information group 134 and the repeated call information group 136 may be integral information.

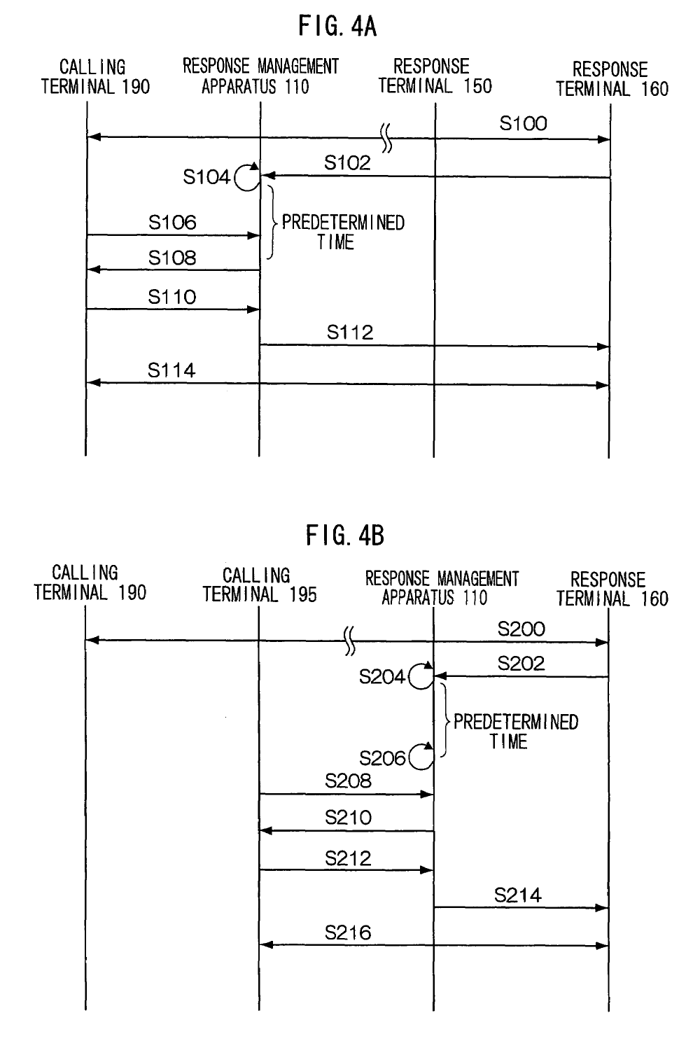

Referring to FIGS. 4A and 4B, the operation of reconnection after call disconnection in the response system 100 according to the embodiment of the invention as described above will be described below. FIGS. 4A and 4B are explanatory views showing the operation of reconnection after call disconnection in the response system 100 according to the embodiment of the invention. FIG. 4A is an explanatory view where there is a repeated call within a predetermined time since the status information indicating the “repeated call waiting” is sent, and FIG. 4B is an explanatory view where the predetermined time passes since the status information indicating the “repeated call waiting” is sent.

First of all, an instance as shown in FIG. 4A will be described below. If the call communication between the calling terminal 190 and the response terminal 160 is disconnected (S 100), the response terminal 160 sends the status information indicating the “repeated call waiting” to the response management apparatus 110 (S102). The response management apparatus 110 receives the status information indicating the “repeated call waiting” sent from the response terminal 160, and registers the repeated call information in the response management storage part 116 (S104).

If there is a repeated call from the calling terminal 190 within the predetermined time from step S104 (S106), the response management apparatus 110 receives the repeated call as indicated at step S106 and makes an automatic response with the IVR, for example (S108). The calling terminal 190 communicates or selects the outline of requirement, for example, in accordance with the automatic response at step S108.

The call distributor part 118 of the response management apparatus 110 determines that the call of the calling terminal 190 is repeated call by checking the determination result in the repeated call determination part 114 and the status of the status information extracted from the response management storage part 116, and the response management apparatus reconnects to the response terminal 160 that makes the call communication with the calling terminal 190 before call disconnection at step S100 (S112).

Herein, at step S112, the repeated call incoming information conveying that there is a repeated call from the calling terminal 190 may be sent from the response management apparatus 110 to the response terminal 160 before reconnection. Through the above steps S102 to S112, the call communication (repeated call communication) between the calling terminal 190 and the response terminal 160 is made (S114).

Accordingly, in the response system according to the embodiment of the invention, the calling terminal can be reconnected to the response terminal making the call communication before call disconnection in the case where there is a phone call again from the calling terminal where call disconnection occurs, as shown in FIG. 4A.

Next, an instance as shown in FIG. 4B will be described below. As in FIG. 4A, if the call communication between the calling terminal 190 and the response terminal 160 is disconnected (S200), the response terminal 160 sends the status information indicating the “repeated call waiting” to the response management apparatus 110 (S202). The response management apparatus 110 receives the status information indicating the “repeated call waiting” sent from the response terminal 160, and registers the repeated call information in the response management storage part 116 (S204).

If a predetermined time passes from step S204, the repeated call information management part 122 of the response management apparatus 110 changes the repeated call capable status of repeated call information registered at step S204 to “time over” to invalidate the repeated call information registered at step S204 (S206). At step S206, the notification information indicating that the repeated call waiting state of the response terminal 160 is cleared (invalidated) may be sent from the response management apparatus 110 to the response terminal 160.

If the incoming call receiving part 112 of the response management apparatus 110 receives an incoming call from the calling terminal 195 (S208), the response management apparatus makes an automatic response with the IVR, for example (S210). The calling terminal 195 communicates or selects the outline of requirement, for example, in accordance with the automatic response at step S210 (S212).

The call distributor part 118 of the response management apparatus 110 determines that the call of the calling terminal 195 is new call (i.e., not repeated call) by checking the determination result in the repeated call determination part 114 and the status of the status information extracted from the response management storage part 116, and automatically decides the response terminal that is connected with the ACD function. Herein, the repeated call waiting state of the response terminal 160 that sends the status information indicating the “repeated call waiting” is invalidated at step S206, and the status of the response terminal is “on standby” indicating the state where the call communication is operable, whereby the call distributor part 118 can connect the calling terminal 195 and the response terminal 160 (S214). Through the above steps S202 to S214, the call communication (new call communication) between the calling terminal 190 and the response terminal 160 is made (S216).

Accordingly, the response system according to the embodiment of the invention can make the efficient response management, because the response terminal does not wait for repeated call more than necessary (predetermined waiting time) by restricting the duration of repeated call waiting state to the predetermined time, as shown in FIG. 4B.

As described above, in the response system 100 according to the embodiment of the invention, the calling terminal can be reconnected to the response terminal making the call communication before call disconnection, in the case where there is a call again from the calling terminal where call disconnection occurs. Also, in the case where the response system 100 according to the embodiment of the invention is applied to the response system for customer such as call center, for example, a so-called “run-around state” is not caused, whereby the customer satisfaction of the customer (calling terminal) making a phone call to the call center is prevented from being degraded and improved.

Also, the response system 100 according to the embodiment of the invention can make the efficient response management, because the response terminal does not wait for repeated call more than the predetermined time. Accordingly, in the case where the response system 100 according to the embodiment of the invention is applied to the response system for customer such as call center, for example, the customer is treated efficiently, whereby the customer satisfaction is prevented from being degraded and improved by shortening the waiting time of the customer (calling terminal) making a phone call to the call center.

Though the response management apparatus 110 has been explained above as the component making up the response system 100 according to the embodiment of the invention, the embodiment of the invention may be applied to the computer such as a server. Also, though the response terminals 150 and 160 have been explained above as the components making up the response system 100 according to the embodiment of the invention, the embodiment of the invention may be applied to the fixed communication apparatus such as a fixed telephone or the computer such as a PC (Personal Computer).

### Program for Response System

A program for response system enables the computer to function as the response management apparatus 110 and the response terminal making up the response system 100 according to the embodiment of the invention as described above. For example, in the case where there is a phone call again from the calling terminal where call disconnection occurs, the calling terminal can be reconnected to the response terminal making the call communication before call disconnection in accordance with the program. Further, the response terminal does not wait for repeated call more than a predetermined waiting time, whereby the efficient response management is made.

### Response Management Method

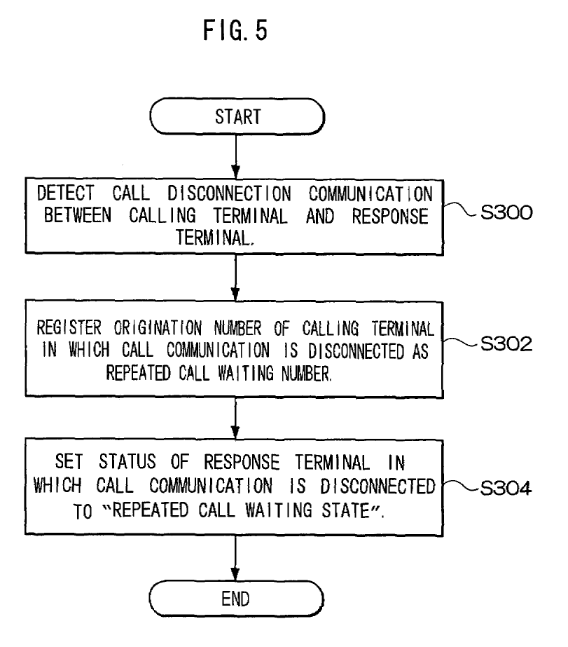

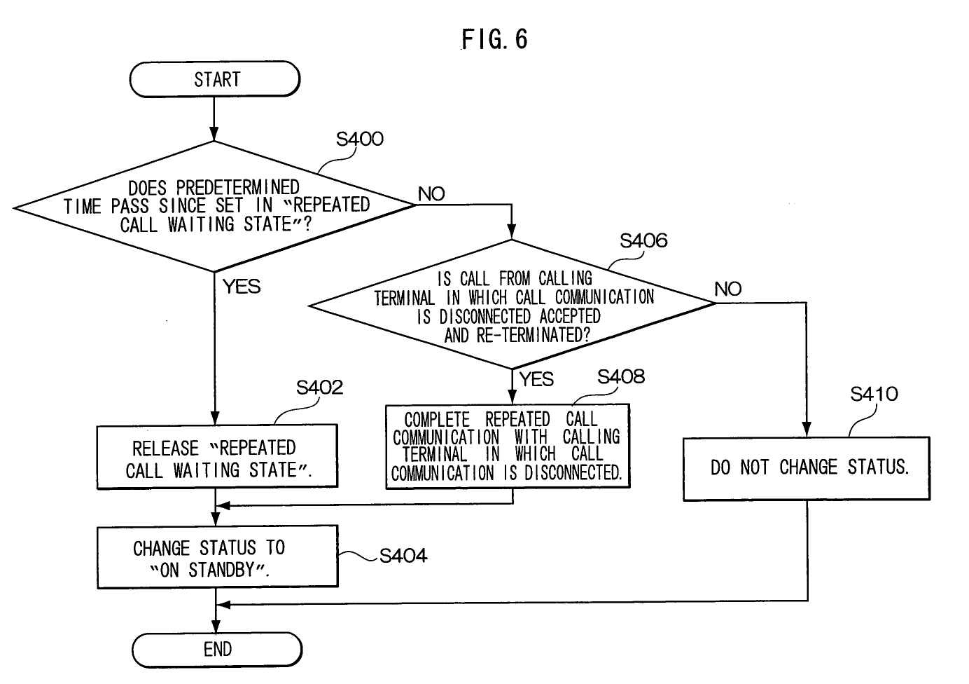

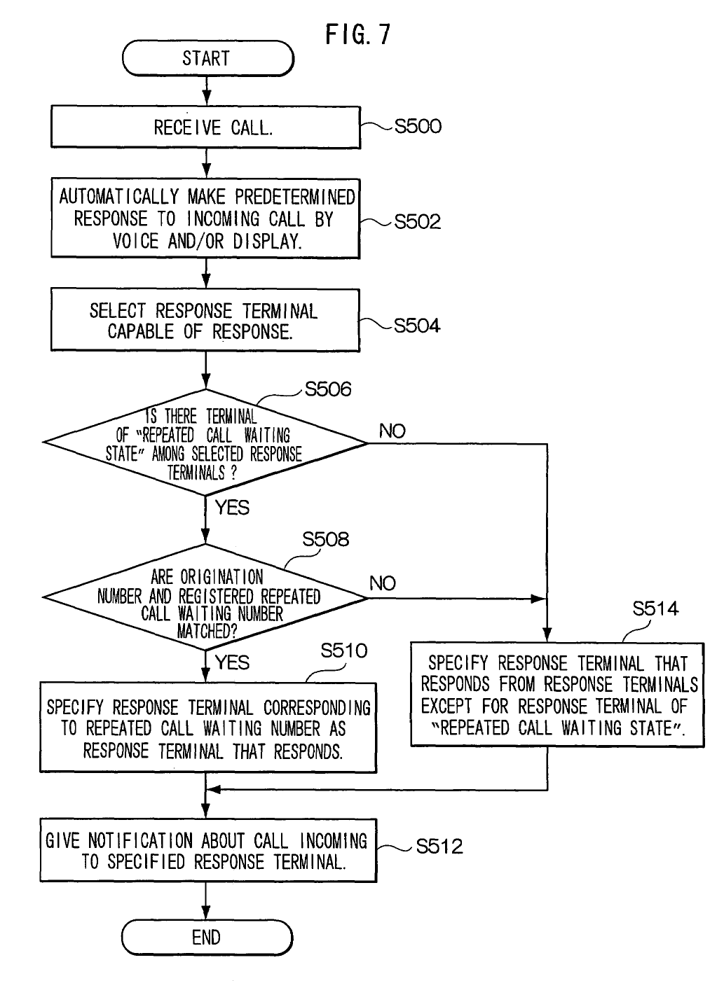

Next, a response management method according to the embodiment of the invention will be described below. FIG. 5 is a flowchart showing a method for setting the status of the response terminal to repeated call waiting state in the response system 100 according to the embodiment of the invention. FIG. 6 is a flowchart showing a method for clearing the repeated call waiting state set at the response terminal in the response system 100 according to the embodiment of the invention. Also, FIG. 7 is a flowchart showing a response management method in the response management apparatus 110 making up the response system 100 according to the embodiment of the invention.

### [Method for Setting the Status of Response Terminal to Repeated Call Waiting State (FIG. 5)]

A disconnection of call communication between the calling terminal and the response terminal is detected (S300). At step S300, if the disconnection of call communication is detected, the inherent origination number of the calling terminal involved in the call communication at step S300 is registered as a repeated call waiting number (S302). Herein, the repeated call waiting number is held in the response management storage part 116 of the response management apparatus 110, for example. Also, the registration of the repeated call waiting number may be performed by the response management apparatus 110, or the response terminal.

And the response management apparatus 110 sets the status of the response terminal involved in the call communication at step S300 to “repeated call waiting state” (S304).

### [Method for Clearing the Repeated Call Waiting State Set at the Response Terminal (FIG. 6)]

Next, a method for clearing the “repeated call waiting state” set at the response terminal in FIG. 5 will be described below. It is determined whether or not a predetermined time passes since the response terminal is set in the “repeated call waiting state” at step S304 of FIG. 5 (S400). Herein, the predetermined time may be appropriately set.

If it is determined at step S400 that the predetermined time passes, the “repeated call waiting state” is cleared (S402), and the status of the response terminal is changed to “on standby” indicating that the call communication is operable (S404).

If it is determined at step. S400 that the predetermined time does not pass, it is determined whether or not the repeated call incoming from the calling terminal in the call communication at step S300 of FIG. 5 is received (S406).

If it is determined at step S406 that the repeated call incoming from the calling terminal involved in the call communication at step S300 of FIG. 5 is received and the call communication with the calling terminal is completed (S408), the status of the response terminal is changed to “on standby” indicating that the call communication is operable (S404).

If it is not determined at step S406 that the repeated call from the calling terminal involved in the call communication at step S300 of FIG. 5 is received, the status set in the response terminal is not changed (S410). Accordingly, the response terminal is kept in the “repeated call waiting state”.

The method for clearing the repeated call waiting state set at the response terminal as shown in FIG. 6 is not performed only once, but may be repeatedly performed if there is any response terminal in the “repeated call waiting state”.

### [Response Management Method in the Response Management Apparatus 110 (FIG. 7)]

Next, a response management method in the response management apparatus 110 will be described below. A call incoming from the calling terminal is received (S500). Herein, the inherent origination number of the calling terminal from which the incoming call is received is held at step S500.

If the incoming call is received at step S500, the response management apparatus 110 automatically performs a predetermined incoming call response by voice and/or display (S502). Herein, owing to the IVR function, for example, the calling terminal may be presented with a selection menu for making a selection at step S502.

The response terminal responsible to the calling terminal to which the response management apparatus automatically makes the incoming call response at step S502 is selected (S504). Herein, if the calling terminal makes the selection with the IVR function at step S502, the response management apparatus selects the response terminal with the selection result as the condition.

It is determined whether or not there is any response terminal in the “repeated call waiting state” among the response terminals selected at step S504 (S506). Herein, the determination at step S506 is made based on the status set or cleared by the method as shown in FIGS. 5 or 6.

If it is not determined at step S506 that there is response terminal in the “repeated call waiting state”, the response terminal that responds to the calling terminal to which the response management apparatus automatically makes the incoming call response at step S502 is specified from among the response terminals except for the response terminal in the “repeated call waiting state” (S514). Herein, at step S514, the response terminal is specified with the ACD function that the call distributor part 118 has. And the specified response terminal is notified that there is incoming call (S512).

If it is determined at step S506 that there is response terminal in the “repeated call waiting state”, it is determined whether or not the inherent origination number of the calling terminal from which the incoming call is received at step S500 and the repeated call waiting number registered at step S302 of FIG. 5 are matched (S508).

At step S508, if there is no repeated call waiting number matched with the inherent origination number of the calling terminal from which the incoming call is received at step S500, the response terminal that responds to the calling terminal to which the response management apparatus automatically makes the incoming call response at step S502 is specified from among the response terminals except for the response terminal in the “repeated call waiting state” (S514). And the specified response terminal is notified that there is incoming call (S512).

If it is determined at step S508 that the inherent origination number of the calling terminal from which the incoming call is received at step S500 and the repeated call waiting number are matched, the response terminal set in the “repeated call waiting state” at step S304 of FIG. 5, namely, the response terminal corresponding to the pertinent repeated call waiting number is specified as the response terminal that responds to the calling terminal to which the response management apparatus automatically makes the incoming call response at step S502 (S510). And the specified response terminal is notified that there is incoming call (S512). Herein, since the response terminal specified at step S510 is the response terminal that receives the repeated call, the notification at step S512 may be repeated call incoming information conveying that there is repeated call.

In the case where there is a phone call again from the calling terminal where call disconnection occurs, the calling terminal can be reconnected to the response terminal making the call communication before call disconnection by using the response management method in the response management apparatus 110 making up the response system 100 according to the embodiment of the invention, as indicated at step S300 to step S514 in FIGS. 5 to 7. Further, since the response terminal does not wait for repeated call more than the predetermined waiting time, the efficient response management can be made.

In the case of applying the method as shown at step S300 to step S514 in FIGS. 5 to 7 to the response system for customer such as a call center, for example, a so-called “run-around state” is not caused, and the waiting time of the customer (calling terminal) making a phone call to the call center can be shortened, whereby the customer satisfaction of the customer (calling terminal) making a phone call to the call center is prevented from being degraded and improved.

While the preferred embodiment of the present invention has been described above with reference to the accompanying drawings, this invention is not limited to the described embodiment. It will be apparent to those skilled in the art that various variations or modifications may be made without departing from the spirit or scope of the invention as defined in the claims, and naturally belong to the technical scope of the invention.

For example, the response management apparatus 110 making up the response system 100 according to the embodiment of the invention comprises separately the status information management part 120 for generally managing the status of the response terminal, and the repeated call information management part 122 for managing the repeated call information. Besides, this invention may have a configuration in which the status information management part and the repeated call information management part may be provided integrally. Even with the configuration, in the case where there is a call again from the calling terminal where call disconnection occurs, the response management apparatus 110 can reconnect the calling terminal to the response terminal making the call communication before call disconnection.

Also, with the method for clearing the repeated call waiting state according to the embodiment of the invention (FIG. 6), the condition of clearing the repeated call waiting state is the case where a predetermined time passes in the “repeated call waiting state” (S400) or the case where the call communication is made again (S406), the invention is not limited to this method. For example, the response terminal sends an instruction of “repeated call waiting clear” to the response management apparatus to clear the repeated call waiting state in accordance with the instruction from the response terminal. Also in this case, the response terminal does not wait for repeated call more than the predetermined waiting time, whereby the efficient response management can be made.

It should be understood that the above configuration may be easily changed by those skilled in the art, and belong to the equivalent range of the invention.

According to a first aspect of the invention, a response system is provided. The response system includes at least one response terminal and a response management apparatus connected to the at least one response terminal. The response terminal includes a status sending part that sends an inherent identification number and the status information indicating at least a repeated call waiting state. The response management apparatus includes: an incoming call receiving part that receives an incoming call from a calling terminal having an inherent origination number; a repeated call determination part that determines whether or not the origination number of the calling terminal from which the incoming call is received by the incoming call receiving part is the origination number at which the call communication is disconnected; a response management storage part that holds the status information set at the at least one response terminal; an incoming call distributor part that selects and connects a response terminal making a response to the call of the calling terminal from the at least one response terminal, based on the determination result of the repeated call determination part and the status information held in the response management storage part; and a status information management part that manages the status information for the at least one response terminal held in the response management storage part.

The response terminal making up the response system is an apparatus for making the call communication with the calling terminal, and has the inherent identification number. Also, the response terminal comprises the status information sending part. With this configuration, the response terminal can send the status information indicating the state waiting for repeated call (repeated call attempt) from the calling terminal because the call communication with the calling terminal is disconnected to the response management apparatus making up the response system, whereby the response management apparatus can set the response terminal in the repeated call waiting state.

The response management apparatus making up the response system comprises an incoming call receiving part, a repeated call determination part, a response management storage part, an incoming call distributor part, and a status information management part. With this configuration, when an incoming call from the calling terminal is received, it is determined whether or not the incoming call is repeated call, and the response terminal that responds to the calling terminal is specified, whereby the specified response terminal and the calling terminal can be connected. Accordingly, when the incoming call is repeated call, the response terminal connected before call disconnection and the calling terminal can be reconnected.

The response management apparatus may further comprise a repeated call information management part for holding the repeated call information including at least the origination number of the calling terminal making the call communication with the response terminal to which the status information is sent and the identification number of the response terminal to which the status information is sent in the response management storage part, in the case where the status information is sent from the status sending part, wherein the repeated call determination part may determine whether or not the origination number is that at which the call communication is disconnected based on the origination number of the calling terminal from which the incoming call is received by the incoming call receiving part and the repeated call information.

With this configuration, the response management apparatus making up the response system further comprises a repeated call information management part for managing the repeated call information. The repeated call information management part manages the repeated call information including the origination number of the calling terminal involved in the disconnected call communication and the identification number of the response terminal, whereby the repeated call determination part can determine whether or not the call is repeated call using the repeated call information.

The repeated call information management part may further hold the time information indicating the time of holding the repeated call information in the repeated call information, and change the repeated call information and clear the repeated call waiting state if a predetermined time passes from the time information.

With this configuration, the repeated call information management part changes the repeated call information and clears the repeated call waiting state if a predetermined time passes from the time information indicating the time of holding the repeated call information. Accordingly, after the predetermined time passes since the status information is sent, the repeated call determination part does not determine that the call is repeated call, using the changed repeated call information, whereby the response terminal making up the response system does not wait for repeated call more than necessary.

The response terminal may further include a display part, the incoming call distributor part may send the repeated call incoming information conveying the repeated call incoming to the response terminal having the identification number corresponding to the origination number, if the repeated call determination part determines that the origination number of the calling terminal from which the incoming call is received is the origination number at which the call communication is disconnected, and the display part may display the repeated call incoming information.

With this configuration, the response terminal making up the response system can display the information sent from the response management apparatus, such as the repeated call incoming information indicating that there is repeated call from the calling terminal, for example. Accordingly, the response terminal can recognize that there is repeated call from the calling terminal while waiting for repeated call.

The response management apparatus may be the response management apparatus for the customer.

If the response management apparatus making up the response system is applied as the response management apparatus for customer, a so-called “run-around state” is not caused, and the waiting time of the customer (calling terminal) can be shortened, whereby the customer satisfaction of the customer (calling terminal) is prevented from being degraded and improved.

According to a second aspect of the invention, a response management apparatus connected to at least one response terminal having an inherent identification number and capable of sending status information indicating a repeated call waiting state. The response management apparatus includes: an incoming call receiving part that receives an incoming call from a calling terminal having an inherent origination number; a repeated call determination part that determines whether or not the origination number of the calling terminal from which the incoming call is received by the incoming call receiving part is the origination number at which the call communication is disconnected; a response management storage part that holds the status information set at the at least one response terminal; an incoming call distributor part that selects and connects a response terminal making a response to the call of the calling terminal from the at least one response terminal, based on the determination result of the repeated call determination part and the status information held in the response management storage part; and a status information management part that manages the status information for the at least one response terminal held in the response management storage part.

The response management apparatus comprises an incoming call receiving part, a repeated call determination part, a response management storage part, an incoming call distributor part, and a status information management part. With this configuration, when an incoming call from the calling terminal is received, it is determined whether or not the incoming call is repeated call, and the response terminal that responds to the calling terminal is specified, whereby the specified response terminal and the calling terminal can be connected. Accordingly, when the incoming call is repeated call, the response terminal connected before call disconnection and the calling terminal can be reconnected.

The response management apparatus may further comprise a repeated call information management part for holding the repeated call information including at least the origination number of the calling terminal making the call communication with the response terminal and the identification number of the response terminal in the response management storage part, in the case where the status information is sent from the status sending part, wherein the repeated call determination part may determine whether or not the origination number is that at which the call communication is disconnected based on the origination number of the calling terminal from which the incoming call is received by the incoming call receiving part and the repeated call information.

With this configuration, the response management apparatus further comprises a repeated call information management part for managing the repeated call information. The repeated call information management part manages the repeated call information including the origination number of the calling terminal involved in the disconnected call communication and the identification number of the response terminal, whereby the repeated call determination part can determine whether or not the call is repeated call using the repeated call information.

The repeated call information management part may further hold the time information indicating the time of holding the repeated call information in the repeated call information, and change the repeated call information and clear the repeated call waiting state if a predetermined time passes from the time information.

With this configuration, the repeated call information management part changes the repeated call information and clears the repeated call waiting state if a predetermined time passes from the time information indicating the time of holding the repeated call information. Accordingly, after the predetermined time passes since the status information is sent, the repeated call determination part does not determine that the call is repeated call, using the changed repeated call information, whereby the response terminal does not wait for repeated call more than necessary.

The incoming call distributor part may send the repeated call incoming information conveying the repeated call incoming to the response terminal having the identification number corresponding to the origination number, if the repeated call determination part determines that the origination number of the calling terminal from which the incoming call is received is the origination number at which the call communication is disconnected.

With this configuration, the response management apparatus can send the repeated call incoming information indicating that there is repeated call from the calling terminal, for example, to the response terminal. Accordingly, the response terminal can recognize that there is repeated call from the calling terminal while waiting for repeated call.

According to a third aspect of the invention, a response terminal that includes a status sending part that sends the inherent identification number and the status information indicating at least the repeated call waiting state to a response management apparatus.

The response terminal is an apparatus for making the call communication with the calling terminal, and has the inherent identification number. Also, the response terminal comprises the status information sending part. With this configuration, the response terminal can send the status information indicating the state waiting for repeated call from the calling terminal because the call communication with the calling terminal is disconnected to the response management apparatus, whereby the response management apparatus can set the response terminal in the repeated call waiting state.

According to a fourth aspect of the invention, a response management method for use in a response system is provided. The system includes at least one response terminal, and a response management apparatus connected to the at least one response terminal. The response management method includes: (a) detecting a disconnection of call communication between a calling terminal and the response terminal and setting the status of the response terminal to the repeated call waiting state; (b) clearing the repeated call waiting state set at the response terminal, if a predetermined condition is met; (c) receiving an incoming call from the calling terminal having an inherent origination number; and (d) specifying the response terminal that responds to the calling terminal based on at least the origination number from which the incoming call is received and the presence or absence of the response terminal in which the status is the repeated call waiting state.

Using this method, the calling terminal can be reconnected to the response terminal making the call communication before call disconnection, when there is a phone call again from the calling terminal where call disconnection occurs.

The step of setting the status of the response terminal in the repeated call waiting state may include a step of detecting a disconnection of call communication between the calling terminal and the response terminal, a step of registering the origination number of the calling terminal involved in the disconnected call communication, and a step of setting the status of the response terminal to the repeated call waiting state.

Using this method, the response terminal can be set in the repeated call waiting state while the correspondence between the calling terminal involved in the disconnected call communication and the response terminal is maintained.

The predetermined condition at the step of clearing the repeated call waiting state may be whether or not the predetermined time passes since the status of the response terminal is set to the repeated call waiting state.

Using this method, the response terminal does not wait for repeated call more than necessary.

The predetermined condition at the step of clearing the repeated call waiting state may be whether or not the call communication between the calling terminal involved in the disconnected call communication and the response terminal is made after the status of the response terminal is set to the repeated call waiting state.

Using this method, the repeated call waiting state of the response terminal is prevented from being not cleared, though the call communication between the response terminal involved in the disconnected call communication and the calling terminal is made again.

Receiving the incoming call at the step of receiving the incoming call may be made in accordance with a predetermined response to the incoming call by using voice and/or display.

Using this method, the response management apparatus can make an automatic response with an interactive voice response (VIR), for example.

The step of receiving the incoming call may further include a step of limiting the response terminal that responds to the calling terminal based on a selection made by the calling terminal in accordance with the predetermined response to the incoming call.

Using this method, the response management apparatus can make the automatic response, and further recognize the outline of requirement for the calling terminal.

The step of specifying the response terminal that responds to the calling terminal may further include a step of determining the presence or absence of the response terminal in which the status is set to the repeated call waiting state, and a step of determining whether or not the received origination number and the registered origination number of the calling terminal involved in the disconnected call communication are matched.

Using this method, the calling terminal and the response terminal can be connected after determining whether or not the call is repeated call.

The step of specifying the response terminal that responds to the calling terminal may further include a step of notifying the repeated call to the specified response terminal.

Using this method, the specified response terminal that is connected to the calling terminal can recognize the incoming call from the calling terminal, and also recognize whether or not the incoming call is repeated call.

With this invention, when there is a phone call again from the calling terminal where call disconnection occurs, the calling terminal can be reconnected to the response terminal making the call communication before call disconnection occurs.

What is claimed is:

1. A response system comprising:
at least one response terminal; and
a response management apparatus connected to the at least one response terminal,
wherein
the response terminal includes a status sending part that sends an inherent identification number and status information indicating at least a repeated call waiting state, and
the response management apparatus includes:
an incoming call receiving part that receives an incoming call from a calling terminal having an inherent origination number;
a repeated call determination part that determines whether or not the origination number of the calling terminal from which the incoming call is received by the incoming call receiving part is the origination number at which a call was disconnected;
a response management storage part that holds the status information set at the at least one response terminal;
an incoming call distributor part that selects and connects a response terminal from the at least one response terminal that responds to the call of the calling terminal, based on the determination result of the repeated call determination part and the status information held in the response management storage part; and
a status information management part that manages the status information held in the response management storage part for the at least one response terminal.

2. The response system of claim 1, further comprising a repeated call information management part that holds repeated call information in the response management storage part, including at least the origination number of the calling terminal making the call to the response terminal to which the status information is sent, and the identification number of the response terminal to which the status information is sent, in a case where the status information is sent from the status sending part,
wherein the repeated call determination part determines whether or not the origination number is that at which the call was disconnected, based on the origination number of the calling terminal from which the incoming call is received by the incoming call receiving part, and the repeated call information.

3. The response system of claim 2, wherein the repeated call information management part further holds time information indicating a time of holding the repeated call information in the repeated call information, and changes the repeated call information, and clears the repeated call waiting state if a predetermined time passes from holding the time information.

4. The response system of claim 2, wherein
the response terminal further includes a display part,
the incoming call distributor part sends the repeated incoming call information conveying the repeated incoming call to the response terminal having the identification number corresponding to the origination number, if the repeated call determination part determines that the origination number of the calling terminal from which the incoming call is received is the origination number at which the call was disconnected, and
the display part displays the repeated incoming call information.

5. The response system of claim 1, wherein the response management apparatus is a response management apparatus for a customer.

6. A response management apparatus connected to at least one response terminal having an inherent identification number and capable of sending status information indicating a repeated call waiting state, the response management apparatus comprising:
an incoming call receiving part that receives an incoming call from a calling terminal having an inherent origination number;
a repeated call determination part that determines whether or not the origination number of the calling terminal from which the incoming call is received by the incoming call receiving part is the origination number at which a call has been disconnected;
a response management storage part that holds the status information set at the at least one response terminal;
an incoming call distributor part that selects and connects a response terminal from the at least one response terminal that responds to the call of the calling terminal, based on the determination result of the repeated call determination part and the status information held in the response management storage part; and
a status information management part that manages the status information held in the response management storage part for the at least one response terminal.

7. The response management apparatus of claim 6 further comprising a repeated call information management part that holds repeated call information in the response management storage part, including at least the origination number of the calling terminal making the call to the response terminal and the identification number of the response terminal, in the case where the status information is sent from the response terminal,
wherein the repeated call determination part determines whether or not the origination number is that at which a call has been disconnected, based on the origination number of the calling terminal from which the incoming call is received by the incoming call receiving part, and the repeated call information.

8. The response management apparatus of claim 7, wherein the repeated call information management part further holds time information indicating a time of holding the repeated call information in the repeated call information, and changes the repeated call information and clears the repeated call waiting state if a predetermined time passes from holding the time information.

9. The response management apparatus of claim 6, wherein the incoming call distributor part sends the repeated incoming call information conveying the repeated incoming call to the response terminal having the identification number corresponding to the origination number, if the repeated call determination part determines that the origination number of the calling terminal from which the incoming call is received is the origination number at which the call was disconnected.

10. A response terminal comprising:
a status sending part that sends an inherent identification number and status information indicating at least a repeated call waiting state to a response management apparatus.

11. A response management method for use in a response system having at least one response terminal, and a response management apparatus connected to the at least one response terminal, the method comprising:
(a) detecting a disconnection of a call between a calling terminal and a response terminal and setting a status of the response terminal to a repeated call waiting state;
(b) clearing the repeated call waiting state set at the response terminal, if a predetermined condition is met;
(c) receiving an incoming call from the calling terminal having an inherent origination number; and
(d) specifying a response terminal to respond to the calling terminal, based on at least the origination number from which of the incoming call, and the presence or absence of a response terminal having a status set to the repeated call waiting state.

12. The response management method of claim 11, wherein (a) includes:
(e) detecting a disconnection of a call between the calling terminal and the response terminal;
(f) registering the origination number of the calling terminal involved in the disconnected call; and
(g) setting the status of the response terminal to the repeated call waiting state.

13. The response management method of claim 11, wherein the predetermined condition in (b) is whether or not a predetermined time has passed since the status of the response terminal was set to the repeated call waiting state.

14. The response management method of claim 11, wherein the predetermined condition in (b) is whether or not a call occurs between the calling terminal involved in the disconnected call and the response terminal, after the status of the response terminal has been set to the repeated call waiting state.

15. The response management method of claim 11, wherein receiving the incoming call in (c) is carried out in accordance with a predetermined response to the incoming call by using at least one of voice and display.

16. The response management method of claim 15, wherein (c) further includes:
(h) limiting the response terminal that responds to the calling terminal based on a selection made by the calling terminal in accordance with the predetermined response to the incoming call.

17. The response management method of claim 12, wherein (d) includes:
(i) determining the presence or absence of a response terminal having a status set to the repeated call waiting state; and
(j) determining whether or not the origination number of the incoming call and the registered origination number of the calling terminal involved in the disconnected call communication are the same.

18. The response management method of claim 17, wherein (d) further includes:
(k) giving notification of the repeated call to the specified response terminal.
